(19) United States
(12) Patent Application Publication
(10) Pub. No.: US 2012/0050793 A1
(43) Pub. Date: Mar. 1, 2012

(54) NETWORK PRINTING SYSTEM, CLIENT TERMINAL, AND PRINTING METHOD

(75) Inventor: Hiroyasu Miyazawa, Tokyo (JP)

(73) Assignee: CANON KABUSHIKI KAISHA, Tokyo (JP)

(21) Appl. No.: 13/180,486

(22) Filed: Jul. 11, 2011

(30) Foreign Application Priority Data
Aug. 31, 2010 (JP) 2010-195072

(51) Int. Cl. G06K 15/02

(52) U.S. Cl. 358/1.15

(57) ABSTRACT

A client terminal in a network printing system including the client terminal, a control server which controls processing for an online document on a network, and an image forming apparatus, comprises a print instruction unit configured to send a print instruction for the online document to the control server by executing processing defined in a script language for the online document accessed via a Web browser of the client terminal, wherein the processing defined in the script language is registered as a bookmarklet in the Web browser, and when printing the accessed online document, processing of the print instruction unit is executed in response to selecting the bookmarklet by a user.

### BACKGROUND OF THE INVENTION

1. Field of the Invention

The present invention relates to a network printing system, client terminal, and printing method. Particularly, the present invention relates to a technique of printing an online document from a mobile client which accesses the online document via a Web browser.

2. Description of the Related Art

Recently, the use of a cloud computing system and SaaS (Software as a Service) technique is becoming popular as a form in which various processes are done on the server computer side. Cloud applications which run on a Web browser have made their debuts and can be utilized even from mobile clients such as a mobile PC and smartphone. In this environment, various printing techniques have been proposed.

For example, Japanese Patent Laid-Open No. 2007-207237 proposes a driverless printing method of sending electronic document data and print setting data to an image forming apparatus to print.

### SUMMARY OF THE INVENTION

The present invention provides to implement quick printing at low communication cost by omitting sending of data laid out for printing to an image forming apparatus via a mobile client in the use of a cloud application with a mobile client or the like.

According to one aspect of the present invention, there is provided a network printing system comprising a client terminal, a control server which controls processing for an online document on a network, and an image forming apparatus, the client terminal comprises a print instruction unit configured to send a print instruction for the online document to the control server by executing processing defined in a script language for the online document accessed via a Web browser of the client terminal, and the control server comprises: a format determination unit configured to receive the print instruction sent from the client terminal, and to determine whether the online document designated by the print instruction has a document format printable by the image forming apparatus; a conversion determination unit configured, when the format determination unit determines that the online document is unprintable, to determine whether a document format of the online document designated by the print instruction can be converted; a conversion unit configured, when the conversion determination unit determines that the document format can be converted, to convert the document format of the online document into a printable document format; and an input unit configured to input actual data of the online document of the printable document format as a printing target in the image forming apparatus.

According to another aspect of the present invention, there is provided a client terminal in a network printing system including the client terminal, a control server which controls processing for an online document on a network, and an image forming apparatus, comprising a print instruction unit configured to send a print instruction for the online document to the control server by executing processing defined in a script language for the online document accessed via a Web browser of the client terminal, wherein the processing defined in the script language is registered as a bookmarklet in the Web browser, and when printing the accessed online document, processing of the print instruction unit is executed in response to selecting the bookmarklet by a user.

According to another aspect of the present invention, there is provided a printing method in a network printing system including a client terminal, a control server which controls processing for an online document on a network, and an image forming apparatus, comprising: in the client terminal, a print instruction step of sending a print instruction for the online document to the control server by executing processing defined in a script language for the online document accessed via a Web browser of the client terminal; in the control server, a format determination step of receiving the print instruction sent from the client terminal, and determining whether the online document designated by the print instruction has a document format printable by the image forming apparatus; a conversion determination step of, when the online document is determined in the format determination step to be unprintable, determining whether a document format of the online document designated by the print instruction can be converted; a conversion step of, when the document format is determined in the conversion determination step to be able to be converted, converting the document format of the online document into a printable document format; and an input step of inputting actual data of the online document of the printable format as a printing target in the image forming apparatus.

The present invention omits sending of data laid out for printing to an image forming apparatus via a mobile client in the use of a cloud application with a mobile client such as a mobile PC or smartphone. The present invention can therefore implement quick printing at low communication cost.

Further features of the present invention will become apparent from the following description of exemplary embodiments (with reference to the attached drawings).

### BRIEF DESCRIPTION OF THE DRAWINGS

FIG. 1 is a view showing the configuration of a network printing system according to the first embodiment;

FIG. 2 is a block diagram showing details of the internal arrangement of an image forming apparatus according to the first embodiment;

FIGS. 3A and 3B are block diagrams showing details of the internal arrangement of an information processing apparatus according to the first embodiment;

FIG. 4 is a block diagram showing the functions of respective apparatuses according to the first embodiment;

FIGS. 5A, 5B, 5C, and 5D are tables each showing a management table;

FIGS. 6A, 6B, 6C, and 6D are views each exemplifying a screen displayed on a browser according to the first embodiment;

FIGS. 7A and 7B are views each exemplifying the description of a script;

FIG. 8 is a flowchart showing processing of sending a print request according to the first embodiment;

FIG. 9 is a flowchart showing sort processing according to the first embodiment;

FIG. 10 is a flowchart showing attribute information acquisition processing according to the first embodiment;

FIG. 11 is a view exemplifying a print execution screen according to the first embodiment;

FIG. 12 is a flowchart showing print execution processing according to the first embodiment;

FIG. 13 is a flowchart showing sort processing according to the second embodiment;

FIG. 14 is a flowchart showing confirmation processing according to the second embodiment;

FIG. 15 is a flowchart showing update processing according to the second embodiment;

FIG. 16 is a flowchart showing sort processing according to the third embodiment;

FIG. 17 is a flowchart showing print request sending processing according to the third embodiment;

FIG. 18 is a flowchart showing update processing according to the third embodiment;

FIG. 19 is a flowchart showing sort processing according to the fourth embodiment; and

FIG. 20 is a flowchart showing print instruction reception processing according to the fourth embodiment.

### DESCRIPTION OF THE EMBODIMENTS

When printing by a client terminal using only a Web browser, data laid out for printing is temporarily downloaded to the client terminal, and the downloaded data is sent to an image forming apparatus. A mobile PC or smartphone serving as the client terminal accesses a network via a public line using wireless communication. The wireless communication is often charged based on the data amount, so exchanging a large amount of data raises the cost depending on the data amount. The public line using wireless communication is lower in communication speed than an intranet (LAN) or the like. For this reason, communication to exchange a large amount of data takes time. In a client environment such as a mobile PC or smartphone, data communication requires high cost and long time to temporarily download data laid out for printing and send the downloaded data to an image forming apparatus.

One purpose of the present invention is to provide a network printing system which solves the above problems.

### First Embodiment

### System Configuration

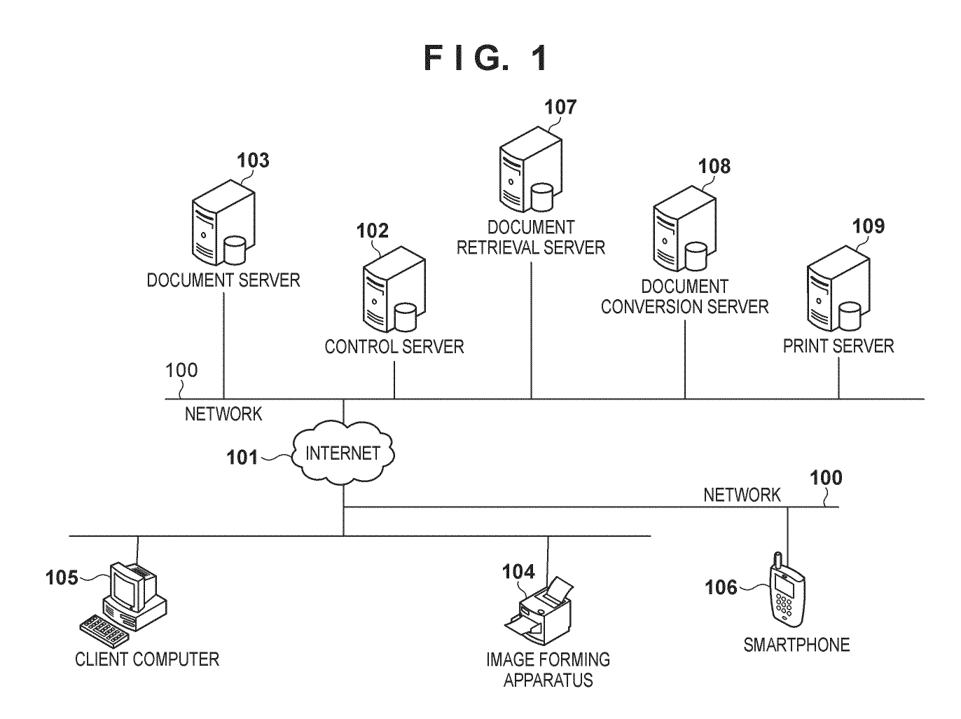

The first embodiment of the present invention will be described below with reference to the accompanying drawings. Respective apparatuses forming a network printing system in the first embodiment will be explained in detail with reference to FIG. 1. FIG. 1 shows a state in which respective apparatuses forming the network printing system are connected via networks 100. The respective apparatuses forming the network printing system are a control server 102, a document server 103, an image forming apparatus 104, a client computer 105, a smartphone 106 serving as a mobile client, a document retrieval server 107, a document conversion server 108, and a print server 109. The networks 100 are communication lines for exchanging information between these apparatuses.

The Internet 101 is a communication line for exchanging information between these apparatuses over a firewall (not shown). The Internet 101 allows the network 100 containing the image forming apparatus 104, client computer 105, and smartphone 106 to communicate over the firewall with the network 100 containing the control server 102 and the like. The networks 100 and Internet 101 are communication networks which support the TCP/IP protocol and the like, regardless of whether they are wired or wireless networks.

In the first embodiment shown in FIG. 1, each server computer such as the control server 102 is represented as one server for each function, but may be formed from a plurality of server computers. Similarly, one computer may have a plurality of functions. Although not shown in FIG. 1, the firewall is generally interposed between the network 100 serving as an internal network and the Internet 101 in order to cut off unwanted communication in communication from the Internet 101 to the network 100 and vice versa in terms of security and the like.

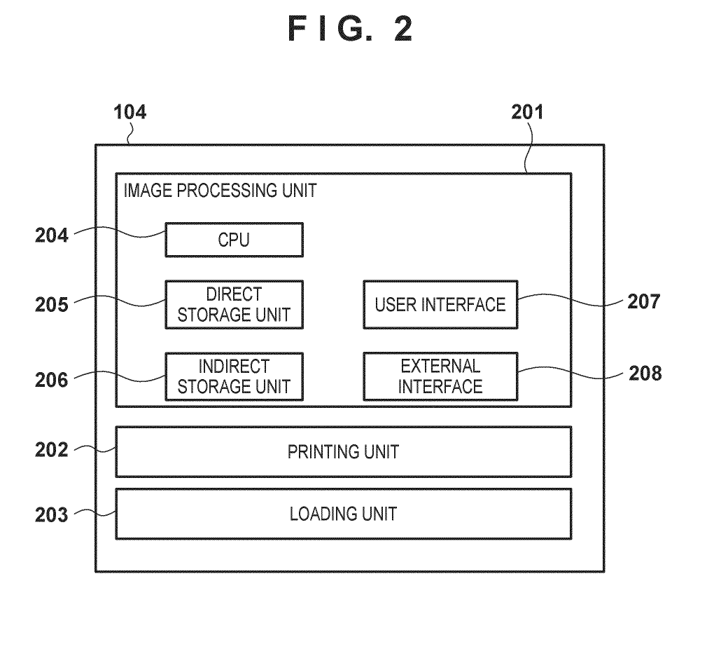

The internal arrangements of the respective apparatuses forming the printing system in FIG. 1 will be described in detail. First, the internal arrangement of the image forming apparatus 104 will be explained with reference to FIG. 2. FIG. 2 is a block diagram exemplifying the internal arrangement of the image forming apparatus 104.

The image forming apparatus 104 includes an image processing unit 201, printing unit 202, and loading unit 203. The image processing unit 201 includes a CPU 204, direct storage unit 205, indirect storage unit 206, user interface 207, and external interface 208.

The CPU 204 is a unit which reads out a predetermined program stored in each storage unit, executes it, and designates various control operations of the image forming apparatus 104. The CPU 204 is implemented by a CPU (Central Processing Unit). The direct storage unit 205 is a work memory used when the CPU 204 executes a program. A program to be executed by the CPU 204 is loaded into the direct storage unit 205. The direct storage unit 205 is implemented by a RAM (Random Access Memory).

The indirect storage unit 206 stores various programs including an application program and platform program. When the CPU 204 is to execute programs, various programs stored in the indirect storage unit 206 are read out and stored in the direct storage unit 205. The indirect storage unit 206 is implemented by an SSD (Solid State Drive) or HDD (Hard Disk Drive). The CPU 204 may be a multiprocessor.

[Platform]

The platform will be described in detail. Implementation of the platform allows executing a new application developed by the user on his own in the image forming apparatus 104, and customizing the operation screen of the image forming apparatus 104.

The platform implementation method will be explained. The CPU 204 reads out a platform program stored in the indirect storage unit 206 and stores it in the direct storage unit 205. Upon completion of storing the program, the CPU 204 can execute the platform program. In the embodiment of the present invention, execution of the platform program by the CPU 204 will be called activation of the platform. Note that the platform runs on the firmware of the image forming apparatus 104. The platform program provides an environment for executing an application program described in an object-oriented language.

A method of executing an application program on the platform will be explained in detail. Printing software configured to accept a print request runs on the platform. The printing software can receive print data from a device connected via the network 100 based on a communication protocol such as HTTP (Hyper Text Transfer Protocol). The printing software sends the received print data to the firmware, and upon receiving the print data, the firmware starts print data processing. Note that the firmware omits print data processing if the print data can be printed without processing it. Print data which can be printed without processing it is, for example, print data which is received with print settings and is free from setting change on the firmware side. Executing an application program on the platform can implement control of the image forming apparatus 104.

An application program execution method will be described. The activated platform reads out an application program stored in the indirect storage unit 206 and stores it in the direct storage unit 205. Upon completion of storing the application program, the platform can execute it. The platform then executes the application program. The platform function which can be provided by executing the application program will be called a “platform application” in the embodiment of the present invention. Further, the platform can perform some of processes in flowcharts to be described in the embodiment of the present invention.

The user interface 207 is used to accept a processing request from the user. For example, the user interface 207 accepts a signal corresponding to an instruction input by the user with a keyboard, mouse, or the like. The external interface 208 can receive data from an external apparatus and send data to it. Examples of the external apparatus are an external storage device such as an external HDD or external USB memory, and a separate apparatus such as a separate host computer or image forming apparatus that is connected via a network. The image forming apparatus 104 can communicate with the client computer 105, smartphone 106, control server 102, and the like via the network 100 and Internet 101.

[Information Processing Apparatus]

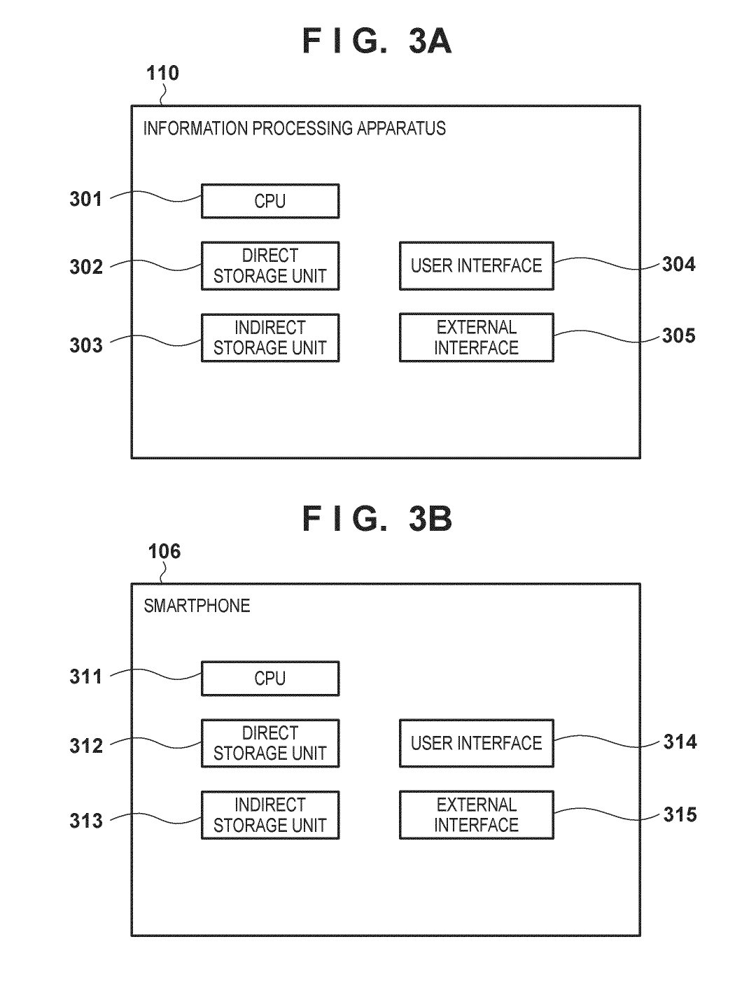

The internal arrangement of an information processing apparatus including the control server 102 and client computer 105 will be explained with reference to FIG. 3A. FIG. 3A is a block diagram exemplifying the internal arrangement of an information processing apparatus 110. The information processing apparatus 110 includes a CPU 301, direct storage unit 302, indirect storage unit 303, user interface 304, and external interface 305. The user interface 304 is used to accept a processing request from the user. For example, the user interface 304 accepts a signal corresponding to an instruction input by the user with a keyboard, mouse, or the like.

The CPU 301 is a unit which executes a predetermined program and designates various control operations of the information processing apparatus 110. The direct storage unit 302 is a work memory used when the CPU 301 executes a program. A program to be executed by the CPU 301 is stored in the direct storage unit 302. The direct storage unit 302 is formed from a RAM. The indirect storage unit 303 stores various programs including an application program and OS (Operating System). When the CPU 301 is to execute programs, various programs stored in the indirect storage unit 303 are read out and stored in the direct storage unit 302. The indirect storage unit 303 is formed from a ROM or HDD. The external interface 305 is connected to the network 100 and can communicate with the remaining apparatuses connected to the network 100.

[Smartphone]

The internal arrangement of the smartphone 106 serving as a mobile client (mobile terminal) will be described with reference to FIG. 3B. FIG. 3B is a block diagram exemplifying the internal arrangement of the smartphone 106. The smartphone 106 includes a user interface 314, CPU 311, direct storage unit 312, indirect storage unit 313, and external interface 315. The user interface 314 is a unit necessary to accept a processing request from the user. The user interface 314 accepts a signal corresponding to an instruction input by the user via a key, touch panel, or the like.

The CPU 311 is a unit which executes a predetermined program and designates various control operations of the smartphone 106. The direct storage unit 312 is a work memory used when the CPU 311 executes a program. A program to be executed by the CPU 311 is stored in the direct storage unit 312. The direct storage unit 312 is formed from a RAM. The indirect storage unit 313 stores various programs including an application program and OS (Operating System). When the CPU 311 is to execute programs, various programs stored in the indirect storage unit 313 are read out and stored in the direct storage unit 312. The indirect storage unit 313 is formed from a ROM or flash memory. The external interface 315 is wirelessly connected to the network 100 and can communicate with the remaining apparatuses connected to the network 100.

[Description of Functions]

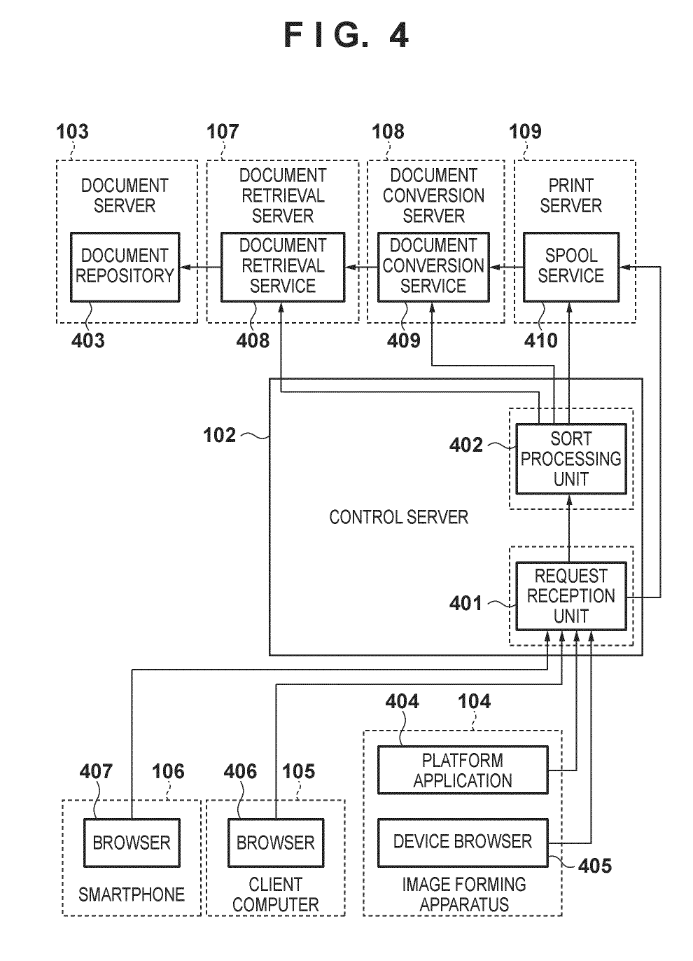

The functions of the respective apparatuses in the printing system according to the embodiment will be described in detail with reference to FIG. 4. FIG. 4 is a block diagram showing the functions of the respective apparatuses in the printing system.

The functions of the control server 102 will be explained first. The control server 102 has the functions of a request reception unit 401 and sort processing unit 402. The request reception unit 401 has a function of accepting a processing request sent from the client computer 105, smartphone 106, or image forming apparatus 104. The sort processing unit 402 has a function of sorting processing requests accepted by the request reception unit 401 to devices (servers) having functions of performing these processes by using a processing program. The sort processing unit 402 performs processing by loading a processing program into the memory of a server computer which executes the sort processing unit 402. The request reception unit 401 and sort processing unit 402 are implemented by reading out, to the direct storage unit 302, a request reception program and sort processing program saved in the indirect storage unit 303 of FIG. 3A, and executing them by the CPU 301. The functions of the control server 102 will be described in more detail later.

The functions of the document server 103 will be explained. The document server 103 has the function of a document repository 403. The document repository 403 is implemented by the indirect storage unit 303 shown in FIG. 3A. For example, the document repository 403 saves contents which are created by the user on the client computer 105 or smartphone 106 via a browser 406 or 407. Contents saved in the document repository 403 include even the following contents in addition to those saved in advance.

Contents other than the saved ones are contents which are created by the user via the browser 406 or 407 using an application in the document server 103. Even contents created using the application in the document server 103 can be easily edited without installing the application in the client computer 105 and smartphone 106. Note that the application in the document server 103 includes various applications such as a document creation application, image creation application, and form management application. These applications are held in the indirect storage unit 303 of FIG. 3A, and in response to an execution instruction from the user, read out to the direct storage unit 302 and executed by the CPU 301.

The image forming apparatus 104 will be described in detail. The image forming apparatus 104 has the functions of a device browser 405 and platform application 404. The device browser 405 has a function of allowing the user to browse data and information saved in a device connected via the network 100. The device browser 405 is implemented by reading out a device browser program saved in the indirect storage unit 206 of FIG. 2, storing it in the direct storage unit 205, and executing it by the CPU 204. The user can issue a content print instruction using the device browser 405. The device browser 405 is, for example, a Web browser.

The platform application 404 has a function of providing various services. The platform application 404 is implemented by an application program running on the platform. In the embodiment of the present invention, the platform application 404 provides a print software service. As described above, this service sends received print data to the firmware. This service inquires of the request reception unit 401 whether generation of print data has ended. At this time, this service checks generation of print data based on a job ID created by the request reception unit 401.

Next, the client computer 105 will be described in detail. The client computer 105 has the function of the browser 406. The browser 406 has a function of allowing the user to browse data and information saved in a device connected via the network 100. The browser 406 is implemented by reading out a browser program saved in the indirect storage unit 303 of FIG. 3A, storing it in the direct storage unit 302, and executing it by the CPU 301. The browser 406 is, for example, a Web browser.

The smartphone 106 will be described in detail. The smartphone 106 has the function of the browser 407. The browser 407 has a function of allowing the user to browse data and information saved in a device connected via the network 100. The browser 407 is implemented by reading out a browser program saved in the indirect storage unit 313 of FIG. 3B, storing it in the direct storage unit 312, and executing it by the CPU 311. The browser 407 is, for example, a Web browser. The Web browser has a bookmark function of allowing the user to register a frequently browsed Web site location (URL: Uniform Resource Locator). With this bookmark function, the user can move to a registered URL by a simple operation such as a selection operation on the touch screen or a click operation with the mouse without inputting a URL or tracking a link in every browsing.

The function of the document retrieval server 107 will be explained. The document retrieval server 107 has the function of a document retrieval service 408. The document retrieval service 408 is recorded as a program in the indirect storage unit 303 of FIG. 3A, read out to the direct storage unit 302, and executed by the CPU 301. The document retrieval service 408 has a function of accessing the document server 103 in accordance with a document retrieval instruction received via the external interface 305, and acquiring a content saved in the document repository 403.

The function of the document conversion server 108 will be explained. The document conversion server 108 has the function of a document conversion service 409. The document conversion service 409 is recorded as a program in the indirect storage unit 303 of FIG. 3A, read out to the direct storage unit 302, and executed by the CPU 301. The document conversion service 409 has a function of converting designated data into a predetermined data format in accordance with a document conversion instruction received via the external interface 305.

Finally, the function of the print server 109 will be explained. The print server 109 has the function of a spool service 410. The spool service 410 is recorded as a program in the indirect storage unit 303 of FIG. 3A, read out to the direct storage unit 302, and executed by the CPU 301. The spool service 410 has a function of generating and assigning an attribute (for example, printing priority or tint information) necessary to print designated data, in accordance with an instruction received via the external interface 305. The functions of the respective apparatuses in the printing system according to the embodiment have been described.

[Print Request Sending Operation]

An operation of sending a print request from the browser 406 or 407 to the request reception unit 401 according to the embodiment will be explained.

[Management Table]

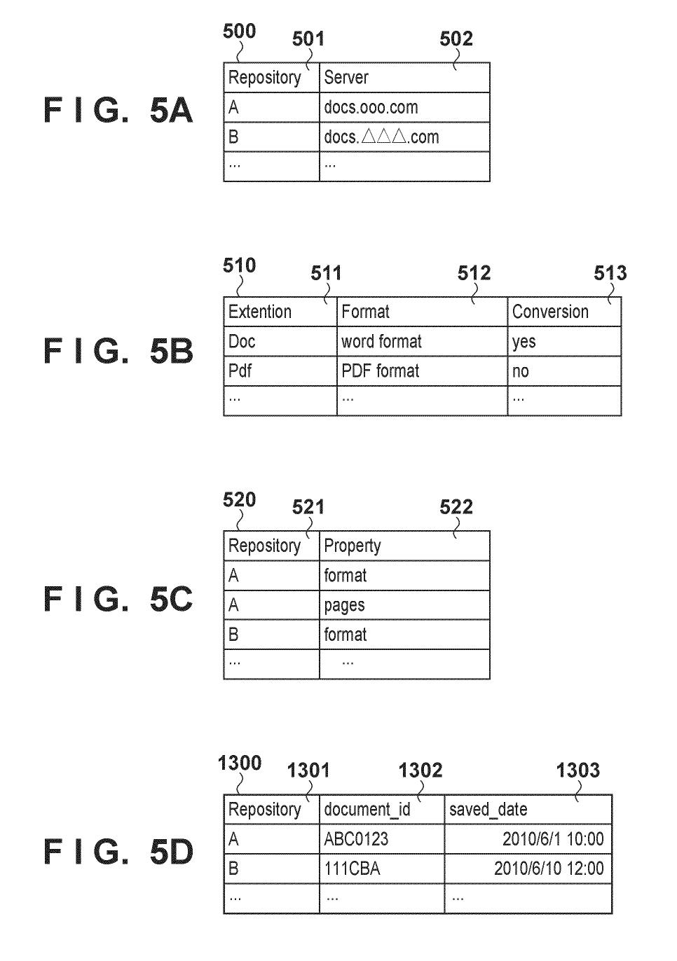

FIG. 5A shows a compliant repository management table 500 which is saved in the indirect storage unit 303 of the control server 102. A document repository 403 complying with the printing system of the present invention is registered in advance and held in the compliant repository management table 500. Items of the compliant repository management table 500 will be explained. Repository 501 is a compliant repository identifier. Server 502 is the actual URL of the compliant document repository 403. In the example shown in FIG. 5A, the URL of compliant repository “A” is “docs.◯◯◯.com”. Also, the URL of compliant repository “B” is “docs.ΔΔΔ.com”.

FIG. 5B shows a compliant format management table 510 which is saved in the indirect storage unit 303 of the control server 102. A document format (to be simply referred to as a format) complying with the printing system of the present invention is registered in advance and held in the compliant format management table 510. Items of the compliant format management table 510 will be explained. Extension 511 is the extension of a compliant format. Format 512 is the name of the format. Conversion 513 is information indicating whether the document conversion service 409 can convert the format. A value “yes” in the Conversion 513 indicates that the format can be converted, and a value “no” indicates that it cannot be converted. In the example shown in FIG. 5B, for the Extension 511=“Doc”, the Format 512 is “word format” and the Conversion 513 is “yes”. For the Extension 511=“Pdf”, the Format 512 is “PDF format” and the Conversion 513 is “no”.

FIG. 5C shows an acquisition attribute management table 520 which is saved in the indirect storage unit 303 of the control server 102. An attribute to be acquired for a compliant repository registered in the compliant repository management table 500 is registered in advance and held in the acquisition attribute management table 520. Items of the acquisition attribute management table 520 will be explained. Repository 521 is the identifier of a compliant repository and corresponds to the Repository 501 registered in the compliant repository management table 500. Property 522 is attribute information to be acquired before retrieving document data from the document repository 403. At this time, a plurality of acquired attributes can be registered for one document repository 403. In the example shown in FIG. 5C, “format” and “pages” are registered in the Property 522 for “A” in the Repository 521.

“format” in the Property 522 represents that the document type attribute can be acquired. Attribute information actually acquired from the document repository 403 is, for example, “word format” or “PDF format”. “pages” in the Property 522 as for the second record in the acquisition attribute management table 520 indicates that the document page count attribute can be acquired. Attribute information actually acquired from the document repository 403 is, for example, “10” indicating a 10-page document. Note that another kind of attribute information may be defined in the Property 522 of the acquisition attribute management table 520. For example, it is also possible to define attribute information such as the paper size or layout necessary for print setting, and acquire a value corresponding to the definition.

[Screen Example]

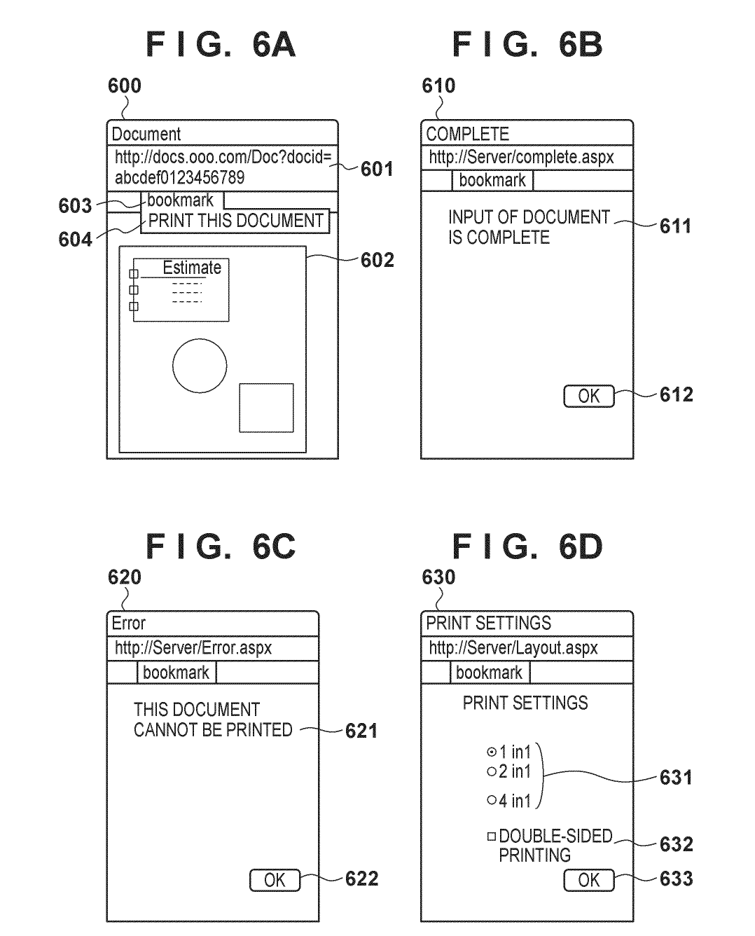

FIG. 6A exemplifies a screen displayed on the browser 406 or 407. A browser screen 600 displays an online document 602 via the browser 406 or 407. The online document 602 is document data stored in the document repository 403. That is, the “online document” is document data stored in an apparatus on the network, and can be referred to from the smartphone or the like via the network 100 and Internet 101.

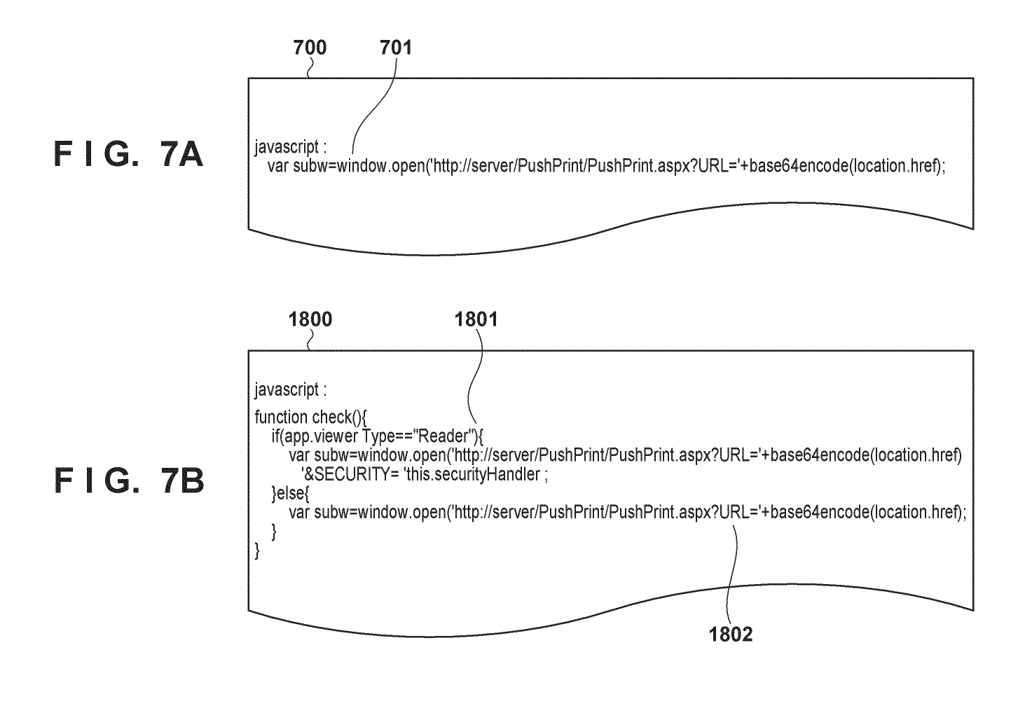

A URL 601 displays a character string indicating the URL of the online document 602. A bookmark 603 is an access means to a bookmark which is a function of the browser 406 or 407. The bookmark is a function of registering an arbitrary URL, and allows moving to a registered URL only by a selection operation by the user. As the bookmark function, the URL of a frequently accessed Web site is registered in advance, and the user selects the registered URL to move to the arbitrary Web site. The embodiment uses this function to register, as a bookmark, the script of an instruction to print an online document currently rasterized on the browser, instead of registering a moving destination URL as a bookmark. A bookmarklet 604 is a kind of bookmark. When the bookmarklet 604 is selected while the browser 406 or 407 displays the online document 602, it sends a request to the request reception unit 401 of the control server 102 to process the online document 602. In the example shown in FIG. 6A, a print instruction request is sent in response to selection of the bookmarklet 604 “print this document.” The bookmarklet 604 will be described later with reference to FIGS. 7A and 7B.

FIG. 6B exemplifies a printing acceptance completion screen displayed on the browser 406 or 407. If a displayed online document is printable after selecting the bookmarklet 604 in the example shown in FIG. 6A, a browser screen 610 appears upon completion of inputting the online document. The browser screen 610 includes a printing acceptance completion message 611 which notifies the user of the completion of printing acceptance, and an OK button 612. The OK button 612 accepts a user instruction, and then the browser screen 610 disappears.

FIG. 6C exemplifies a printing acceptance error screen displayed on the browser 406 or 407. If the displayed document data is unprintable after selecting the bookmarklet 604 in the example shown in FIG. 6A, a browser screen 620 appears. The browser screen 620 includes a printing acceptance error message 621 which notifies the user of a printing acceptance error, and an OK button 622. The OK button 622 accepts a user instruction, and then the browser screen 620 disappears.

FIG. 6D exemplifies a print setting screen displayed on the browser 406 or 407. After the browser screen 610 shown in FIG. 6B disappears, a browser screen 630 appears to input print settings to print document data. The browser screen 630 includes an imposition selection option 631, double-sided printing selection option 632, and setting send button 633. The imposition selection option 631 is an option button to select an Nin1 setting, and accepts a user instruction. The double-sided printing selection option 632 is a check box to select whether to perform double-sided printing, and accepts a user instruction. When a user instruction is accepted in response to selecting the setting send button 633, the selection states of the imposition selection option 631 and double-sided printing selection option 632 are sent as print setting information to the request reception unit 401 of the control server 102. Then, the browser screen 630 disappears.

[Example of Script Description]

FIG. 7A exemplifies a script which is described in a script language and forms the bookmarklet 604 of the browser screen example shown in FIG. 6A. The bookmarklet 604 is formed from a script 700 interpretable by the browsers 406 and 407, such as JavaScript®. A print request sending script is the entity of the script 700, and describes sending of the URL of the online document 602 displayed on the browser 406 or 407 to the URL of the request reception unit 401 of the control server 102. In this example, the URL “location.href” of the browser screen 600 is sent to a URL “http://server/PushPrint/PushPrint.aspx” indicating the request reception unit 401. In the example shown in FIG. 6A, “http://docs.◯◯◯.com/Doc?docid=abcdef0123456789” is sent as a parameter to the request reception unit 401. This information (URL) can be used to specify the location of an online document or the like.

A method of registering a script as the bookmarklet 604 will be described. In the embodiment, a script to issue an online document print instruction to the control server 102 is registered in advance as the bookmarklet 604 in the browser of the smartphone 106 or the like. The bookmarklet 604 can be registered by various methods. In this case, the script is acquired from a server providing predetermined scripts, and registered as a bookmarklet.

More specifically, a script (see FIG. 7A) described as an instruction to print an online document is acquired from a Web server (not shown) which provides scripts. The acquired script is registered as a bookmarklet in the browser 406 of the smartphone 106 or the like. As a result, the user can select the script on the browser as the bookmarklet 604 for an online document print instruction, as shown in FIG. 6A. This script implements processing of acquiring, from the URL of an online document accessed by the user, information which specifies the online document, and sending an instruction to the control server 102 to print the online document, as described above.

Note that the description contents of a script to be acquired are not limited to the contents shown in FIG. 7A. For example, the script may further contain a description to output a confirmation screen to the user when issuing a print instruction. Further, the above description sends a print instruction containing the entire URL of an online document. However, only part of the URL may be extracted, and only the information may be contained in an instruction to be sent.

[Print Request Sending Processing Sequence]

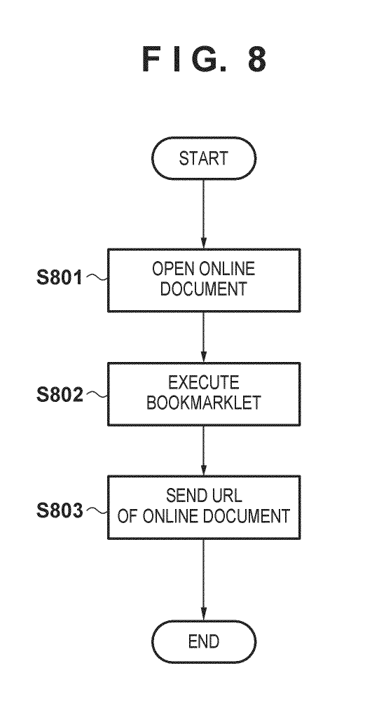

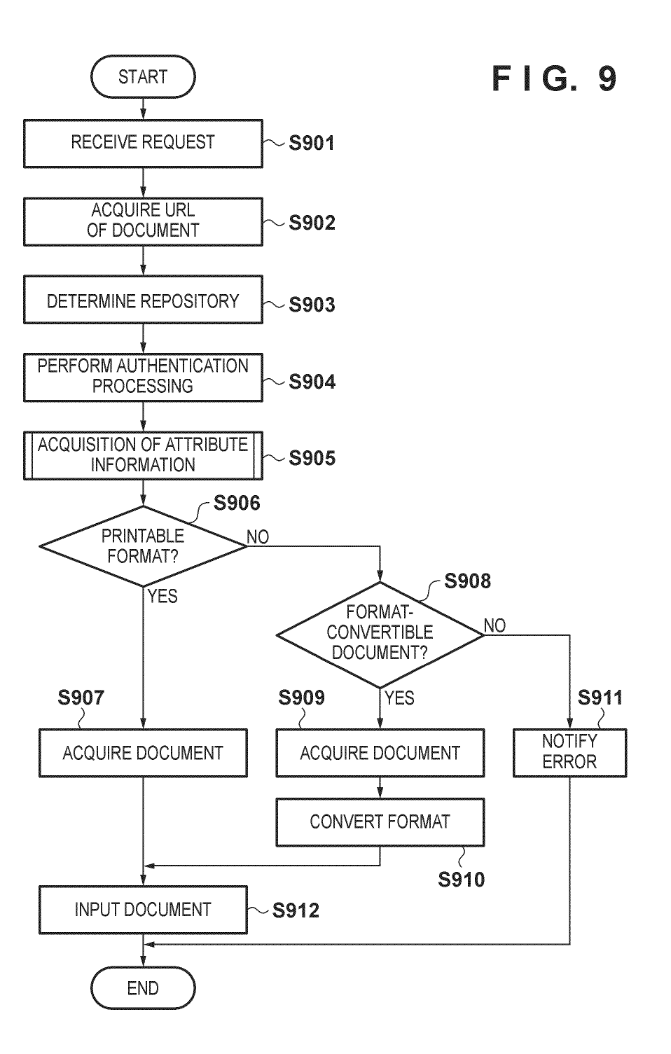

FIG. 8 is a flowchart showing processing of sending a print request from the browser 406 or 407 to the request reception unit 401 according to the embodiment. In the embodiment, this processing is implemented by reading out a program stored in each storage unit and executing it by the CPU of the smartphone 106 or client computer 105.

In step S801, the browser 406 or 407 receives a user operation, opens document data (online document) in the document repository 403, and displays it, like the online document 602 shown in FIG. 6A. In step S802, the browser 406 or 407 receives a selection operation to the bookmark 603 from the user, and loads and executes the script of the bookmarklet 604. The script loaded at this time has been registered as a bookmarklet, as described above. In step S803, the browser 406 or 407 sends the URL 601 of the online document 602 to the request reception unit 401 in accordance with the bookmarklet executed in step S802. Then, the processing of sending a print request from the browser 406 or 407 to the request reception unit 401 according to the embodiment ends.

[Sort Processing Sequence]

An operation of receiving the above-mentioned print request by the control server 102, acquiring the attribute of document data, and sorting processes based on the acquisition result according to the embodiment will be explained. FIG. 9 is a flowchart showing a processing sequence of receiving a print request by the control server 102, acquiring the attribute of a document, and sorting processes based on the document attribute acquisition result. In the embodiment, this processing is implemented by reading out a program stored in each storage unit and executing it by the CPU of the control server 102.

In step S901, the request reception unit 401 receives a print request which has been sent from the browser 406 or 407 in step S803, and transfers it to the sort processing unit 402. In step S902, the sort processing unit 402 acquires the URL of the online document 602 from the print request received in step S901. In the example shown in FIG. 6A, the parameter value “http://docs.◯◯◯.com/Doc?docid=abcdef0123456789” expressed as “URL” is acquired. This URL information designates an online document. In step S903, the sort processing unit 402 confirms that the document repository 403 which stores the online document 602 complies with the network printing system according to the present invention. More specifically, the sort processing unit 402 confirms that the record of the document repository 403 of the URL acquired in step S902 exists in the compliant repository management table 500 described with reference to FIG. 5A. If the record having “docs.◯◯◯.com” exists in the column of the Server 502, the sort processing unit 402 determines that the document repository 403 complies with the network printing system according to the present invention.

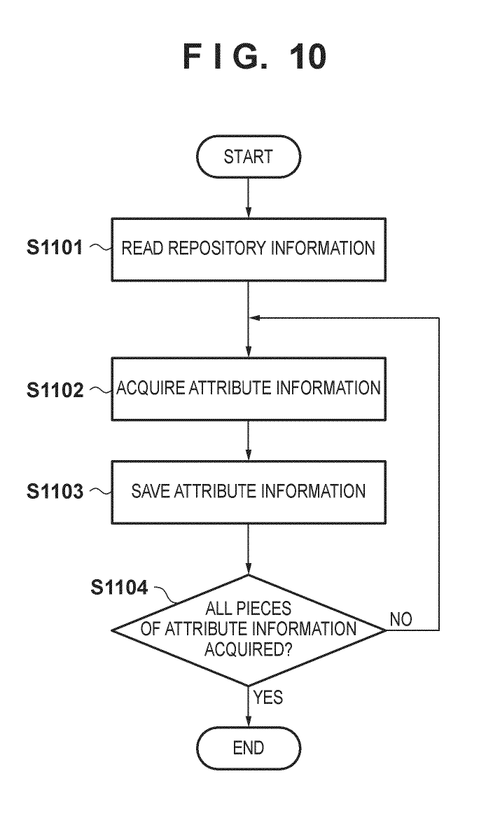

In step S904, the sort processing unit 402 performs authentication processing to access the document repository 403 confirmed in step S903. This authentication processing may be set on the premise that the control server 102 and document repository 403 have a relationship of trust, or the user may be prompted to input authentication information via the browser 406 or 407. In step S905, the sort processing unit 402 acquires attribute information of the online document 602 for an item corresponding to the document repository 403. This processing will be explained below with reference to FIG. 10.

In step S906, the sort processing unit 402 determines, from the attribute information acquired in step S905, whether the online document 602 has a format printable by the image forming apparatus. It is determined that the format is printable when a format corresponding to the acquired attribute information exists in the compliant format management table 510 described with reference to FIG. 5B and no format need be converted. For example, when attribute information of the online document 602 is “Pdf”, the compliant format management table 510 has a record in which the Extension 511 is “Pdf” and the Conversion 513 is “no” in the example shown in FIG. 5B. Thus, it is determined that the format is printable. This implements a format determination unit. If YES in step S906, the sort processing unit 402 acquires the entity file of the online document 602 from the document repository 403 via the document retrieval service 408 (step S907).

If NO in step S906, the sort processing unit 402 determines, from the attribute information acquired in step S905, whether the online document 602 has a format which becomes printable by the image forming apparatus after format conversion (step S908). For example, when attribute information of the online document 602 is “Doc”, the compliant format management table 510 has a record in which the Extension 511 is “Doc” and the Conversion 513 is “yes” in the example shown in FIG. 5B. It is therefore determined that the format becomes printable after format conversion. This implements a conversion determination unit. If YES in step S908, the sort processing unit 402 acquires the entity file of the online document 602 from the document repository 403 via the document retrieval service 408 (step S909). In step S910, the sort processing unit 402 sends, to the document conversion service 409 of the document conversion server 108, the entity file of the online document 602 that has been acquired in step S909, and requests the document conversion service 409 to convert the format. At this time, the document conversion service 409 of the document conversion server 108 converts the entity file of the online document 602 into a file of a printable format, and notifies the sort processing unit 402 of the control server 102 of this.

If NO in step S908, the sort processing unit 402 determines that the online document 602 is unprintable. The sort processing unit 402 sends the browser screen 620 to the browser 406 of the client computer 105 or the browser 407 of the smartphone 106 via the request reception unit 401 (step S911).

After the processing in step S907 or S910, the sort processing unit 402 of the control server 102 sends, to the spool service 410 of the print server 109 in step S912, the file of actual data of the online document 602 that has been acquired in step S907 or the file of actual data obtained by converting the format of the online document 602 in step S910. The spool service 410 receives and inputs the file as a printing target, and waits for execution of printing as a printable state. Then, the sort processing unit 402 of the control server 102 sends the browser screen 610 to the browser 406 of the client computer 105 or the browser 407 of the smartphone 106 via the request reception unit 401.

In this processing sequence, whether an online document is printable is determined based on the format of the online document or format conversion possible/impossible attribute information. However, the determination is not limited to this, and whether an online document is printable may be determined based on, for example, the function of the image forming apparatus. In this case, determination processing becomes possible by adding information of the image forming apparatus to information held in the respective management tables shown in FIGS. 5A to 5C, and managing attribute information indicating correspondence between an image forming apparatus and an online document format printable by it.

In this way, pieces of information held in the respective management tables shown in FIGS. 5A to 5C are not limited to the above ones, and attribute information used for the function of each apparatus or determination may be further added.

[Attribute Information Acquisition Processing Sequence]

FIG. 10 is a flowchart showing a processing sequence of acquiring attribute information of the online document 602 for an item corresponding to the document repository 403 in step S905 of FIG. 9. This processing sequence is implemented by reading out a program stored in each storage unit and executing it by the CPU.

In step S1001, the sort processing unit 402 acquires, from the acquisition attribute management table 520 described with reference to FIG. 5C, a record corresponding to the document repository 403 that has been acquired in step S903. For example, when the document repository 403 is “docs.◯◯◯.com”, the Repository 501 is “A”, and a record having “A” on the column of the Repository 521 is acquired from the acquisition attribute management table 520. In the example shown in FIG. 5C, the sort processing unit 402 acquires records having “format” indicating the format and “pages” indicating the page count on the column of the Property 522.

In step S1002, the sort processing unit 402 accesses the document repository 403 to acquire attribute information of an online document 602 corresponding to the attribute (for example, “format”) acquired in step S1001. This is implemented by making an inquiry to the attribute information acquisition WebService API of the document repository 403 from the sort processing unit 402 using the identifier of the online document 602 as a key. As a result of the inquiry, for example, attribute information “Pdf” corresponding to “format” is acquired. In step S1003, the sort processing unit 402 temporarily saves, in the direct storage unit 302, the attribute information of the online document 602 that has been acquired in step S1002.

In step S1004, the sort processing unit 402 determines whether all pieces of attribute information of the online document 602 that correspond to the records acquired in step S1001 (for which it is registered that they need to be acquired) have been acquired. If YES in step S1004, the sort processing unit 402 determines that all pieces of attribute information of the online document 602 have been acquired, and the processing ends. If NO in step S1004, the sort processing unit 402 determines that not all pieces of attribute information of the online document 602 have been acquired. The process returns to step S1002 to continue acquisition of attribute information of the online document 602.

[Example of Print Selection Screen]

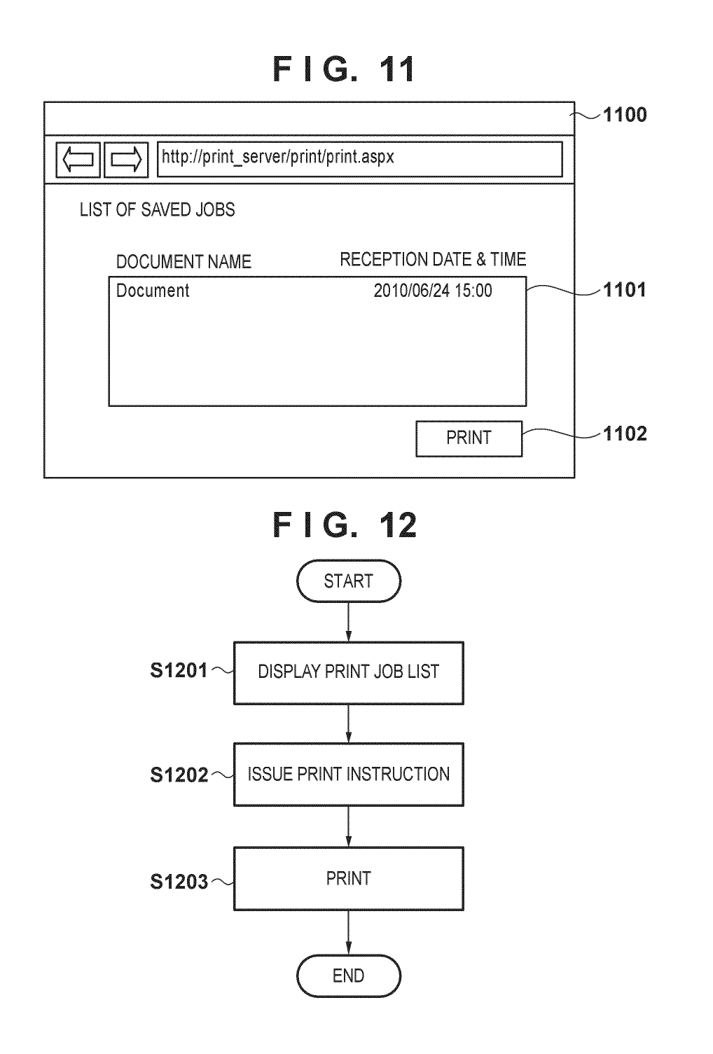

FIG. 11 exemplifies a screen for printing the online document 602 sent to the spool service 410 in step S908 of FIG. 9 by the platform application 404 of the image forming apparatus 104. A print selection screen 1100 is the screen of the platform application 404. The image forming apparatus 104 is connected to the spool service 410 of the print server 109 via the network 100 and Internet 101.

As a saved job list 1101, the platform application 404 displays, from the spool service 410, a list of online document jobs matching the ID of a user who operates the print selection screen 1100. The saved job list 1101 can accept a user operation of selecting a saved job displayed in the list. A print button 1102 can accept a print instruction from the user. Upon receiving a print instruction, the platform application 404 acquires the online document 602 selected in the saved job list 1101, and the printing unit 202 executes printing.

[Print Processing Sequence]

FIG. 12 is a flowchart showing processing of executing printing by the image forming apparatus 104 in accordance with a print job selected in the print selection screen 1100 shown in FIG. 11. In step S1201, the platform application 404 displays, in the saved job list 1101 from the spool service 410, a list of online document jobs matching the ID of a user who operates the print selection screen 1100. In step S1202, the platform application 404 receives a user instruction issued by selecting the online document 602 in the saved job list 1101 and pressing the print button 1102. In step S1203, the platform application 404 acquires print data of the online document 602 from the spool service 410 based on the user instruction received in step S1202, and the printing unit 202 executes printing. Then, the print processing by the image forming apparatus in the embodiment ends.

As described above, the first embodiment can implement quick printing at low communication cost by omitting sending of data laid out for printing to an image forming apparatus via a mobile client such as a mobile PC or smartphone in a cloud application.

### Second Embodiment

The second embodiment manages the identifier of an online document for which a print instruction has failed. According to this embodiment, even if the document repository URL differs between respective browsers, when the user issues again an instruction to print this online document, he is notified that the online document is unprintable, without acquiring it.

FIG. 5D shows an unprintable document management table 1300 which is saved in an indirect storage unit 303 of a control server 102. An online document 602 which could not be printed is recorded and held in the unprintable document management table 1300.

Repository 1301 is a field indicating the identifier of a compliant repository, and corresponds to Repository 501 shown in FIG. 5A. document_id 1302 is a field indicating an identifier for which printing has failed owing to attribute information of the online document 602. saved_date 1303 is a field indicating a date & time when the online document 602 indicated by the document_id 1302 was saved. In this example, for a compliant repository with an identifier “A”, an online document with an identifier “ABC0123” could not be printed on the save date & time “2010/6/1 10:00”. Similarly, for a compliant repository with an identifier “B”, an online document with an identifier “111CBA” could not be printed on the save date & time “2010/6/10 12:00”.

[Sort Processing Sequence]

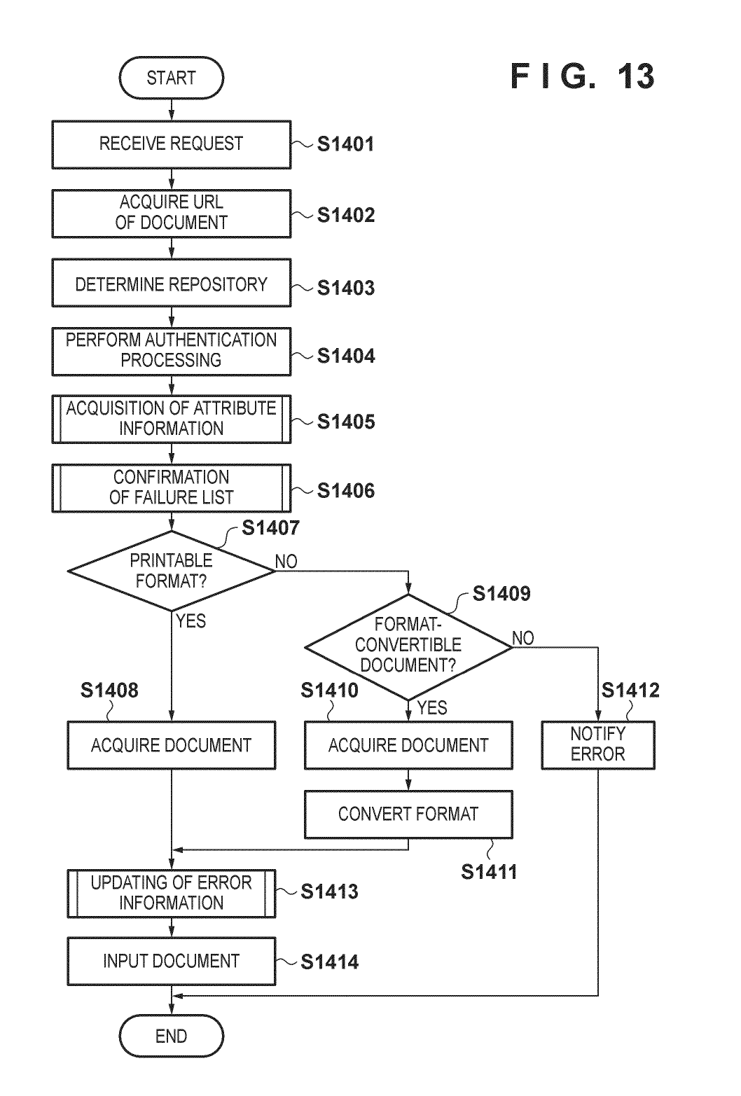

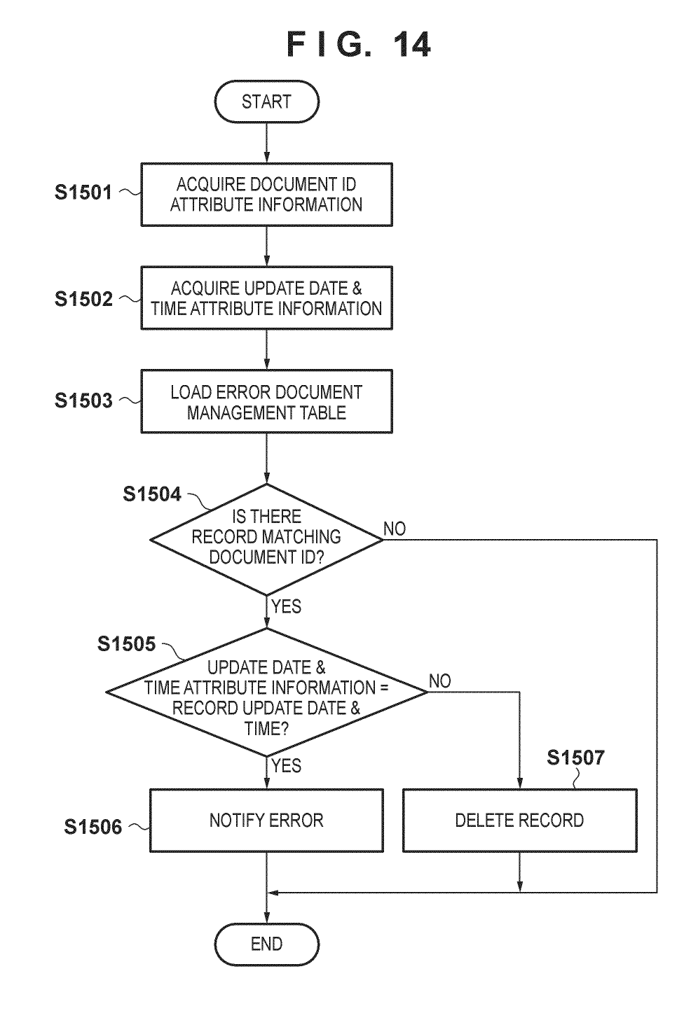

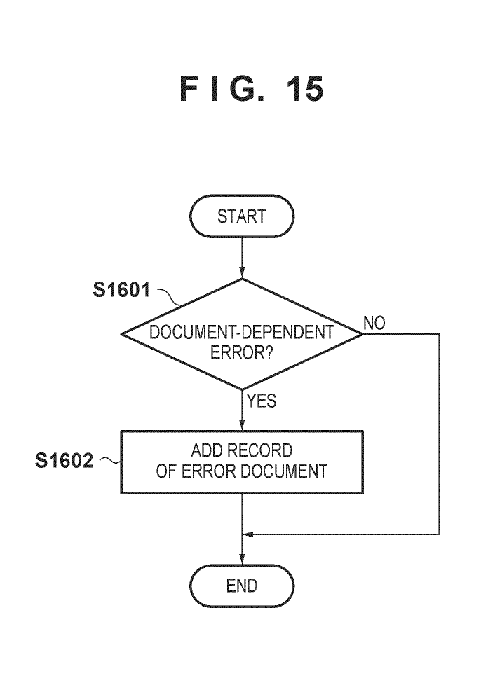

FIG. 13 is a flowchart showing a processing sequence of receiving a print request by the control server 102, acquiring the attribute of document data, and sorting processes based on the document attribute acquisition result. This processing sequence corresponds to FIG. 9 described in the first embodiment. A description of the same processes will not be repeated. Steps S1401 to S1405 are the same as step S901 to S905 in FIG. 9. In step S1406, a sort processing unit 402 determines that the record of a printing-requested online document 602 exists in the unprintable document management table 1300 described with reference to FIG. 5D. Details of this processing will be described later with reference to FIG. 14. Steps S1407 to S1412 are the same as steps S906 to 5911 in FIG. 9. In step S1413, the sort processing unit 402 updates data of the unprintable document management table 1300. Details of this processing will be described later with reference to FIG. 15. Step S1414 is the same as step S912 in FIG. 9. After that, the processing sequence ends.

[Failure List Confirmation Processing Sequence]

FIG. 14 is a flowchart showing a sequence of processing (corresponding to step S1406 in FIG. 13) of confirming, by the sort processing unit 402, whether the record of the printing-requested online document 602 exists in the unprintable document management table 1300 described with reference to FIG. 5D. This processing sequence is implemented by reading out a program stored in each storage unit and executing it by the CPU.

In step S1501, the sort processing unit 402 acquires document_id information serving as the identifier of the online document 602 from the attribute information acquired in step S1405 of FIG. 13. In step S1502, the sort processing unit 402 acquires update date & time information of the online document 602 from the attribute information acquired in step S1405. In step S1503, the sort processing unit 402 loads the unprintable document management table 1300.

In step S1504, the sort processing unit 402 determines whether a record having document_id acquired in step S1501 exists in the data loaded in step S1503. If YES in step S1504, the sort processing unit 402 determines whether a record matching the update date & time acquired in step S1502 exists in the data loaded in step S1503 (step S1505). If NO in step S1504, the processing sequence ends. If YES in step S1505, the sort processing unit 402 determines that the online document 602 could not be printed in the past, and notifies a browser 406 or 407 via a request reception unit 401 that the online document 602 is unprintable (step S1506). If NO in step S1505, the sort processing unit 402 determines that the online document 602 could not be printed in the past but the update date & time is different, and deletes the record matching document_id from the unprintable document management table 1300 (step S1507). After the processing in step S1506 or S1507, the processing sequence ends.

If the error notification processing in step S1506 is executed in FIG. 14, the processing sequence may end without performing subsequent determination processing (steps S1407 to S1414) shown in FIG. 13.

[Update Processing Sequence]

FIG. 15 is a flowchart showing a sequence of processing (corresponding to step S1414 in FIG. 13) of updating data of the unprintable document management table 1300 by the sort processing unit 402. This processing sequence is implemented by reading out a program stored in each storage unit and executing it by the CPU.

In step S1601, the sort processing unit 402 determines whether printing is impossible in steps S1407 to S1411 of FIG. 13. In the embodiment, it is determined that printing is impossible when a document conversion service 409 of a document conversion server 108 fails to convert the format in step S1411 or the process shifts to step S1412. If YES in step S1601, the sort processing unit 402 adds, to the unprintable document management table 1300, a record having the document repository identifier Repository, document_id, and update date & time of the online document 602 (step S1602). The processing sequence then ends. If NO in step S1601, the sort processing unit 402 determines that printing is possible, and the processing sequence ends.

As described above, the identifier of an online document for which a print instruction has failed is managed. Even if the document repository URL differs between respective browsers, the user can be notified that the online document is unprintable, without acquiring it again. This can prevent wasteful communication.

### Third Embodiment

The third embodiment checks security information (environment or encryption) in execution of a bookmarklet, and manages the identifier of an online document 602 for which a print instruction has failed owing to encryption. According to this embodiment, when the user issues again an instruction to print this online document, he is notified that the online document is unprintable without acquiring it. For example, the third embodiment is applicable to a case in which an online document has been encrypted and can be browsed with the function of a tool on a client terminal but cannot be printed in terms of security.

Note that the security information is information indicating whether the online document 602 has been encrypted. For example, a flag may be used to indicate encryption/non-encryption and managed in correspondence with an online document. Alternatively, information indicating an encryption method may be used.

[Sort Processing Sequence]

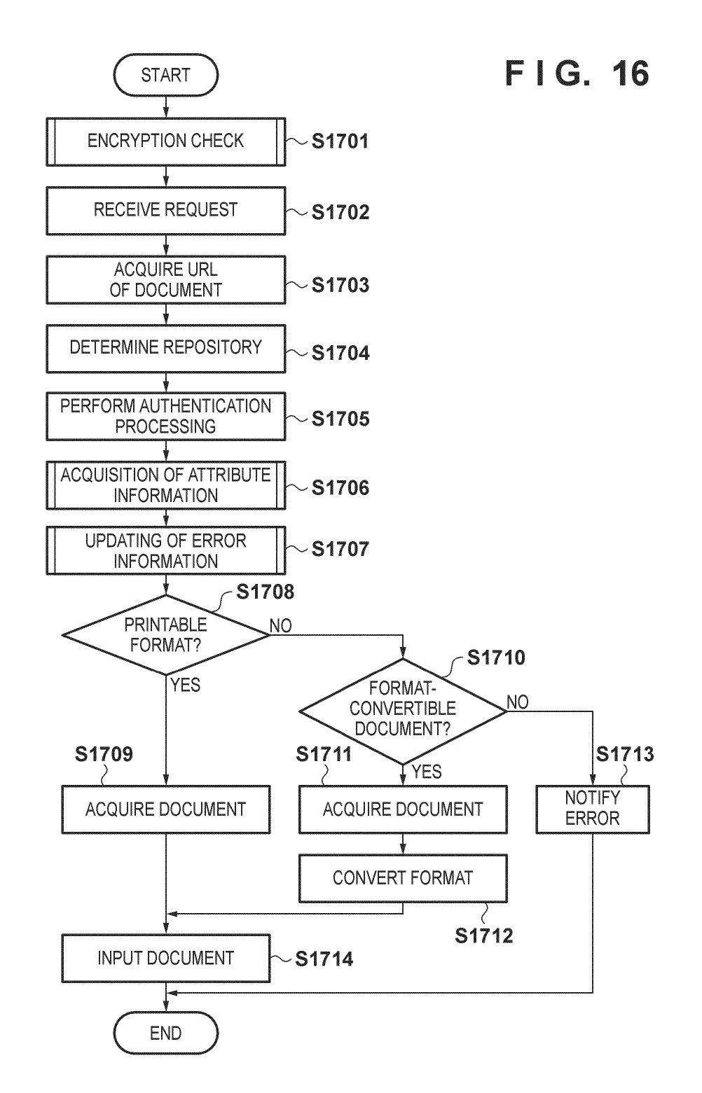

FIG. 16 is a flowchart showing a processing sequence of receiving a print request by a control server 102, acquiring the attribute of document data, and sorting processes based on the document attribute acquisition result. This processing sequence corresponds to FIG. 9 described in the first embodiment. A description of the same processes will not be repeated.

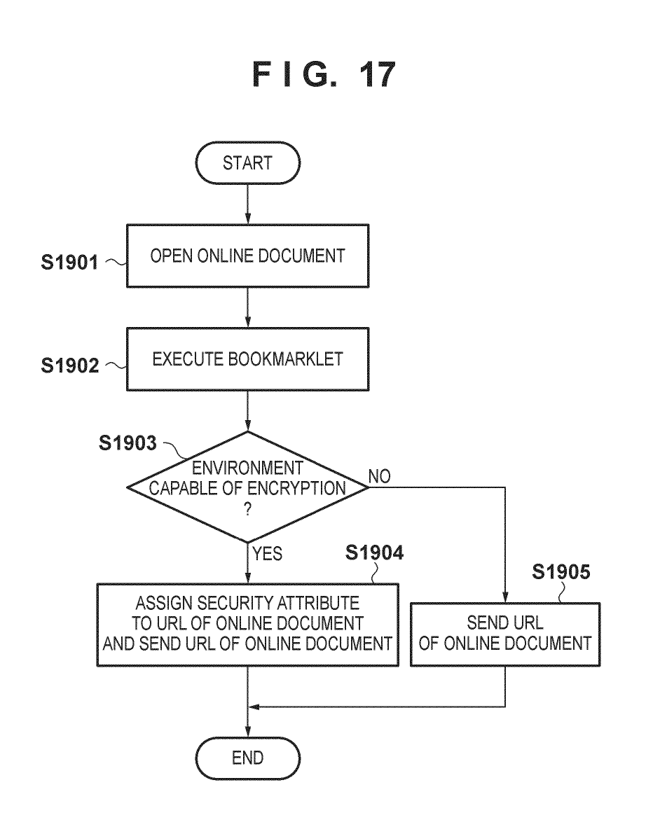

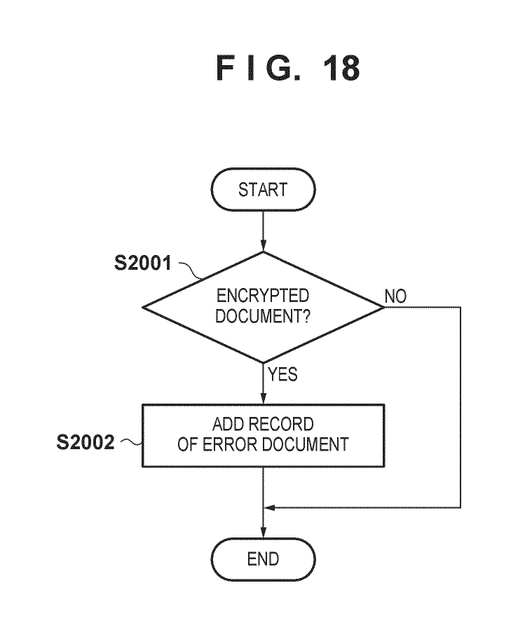

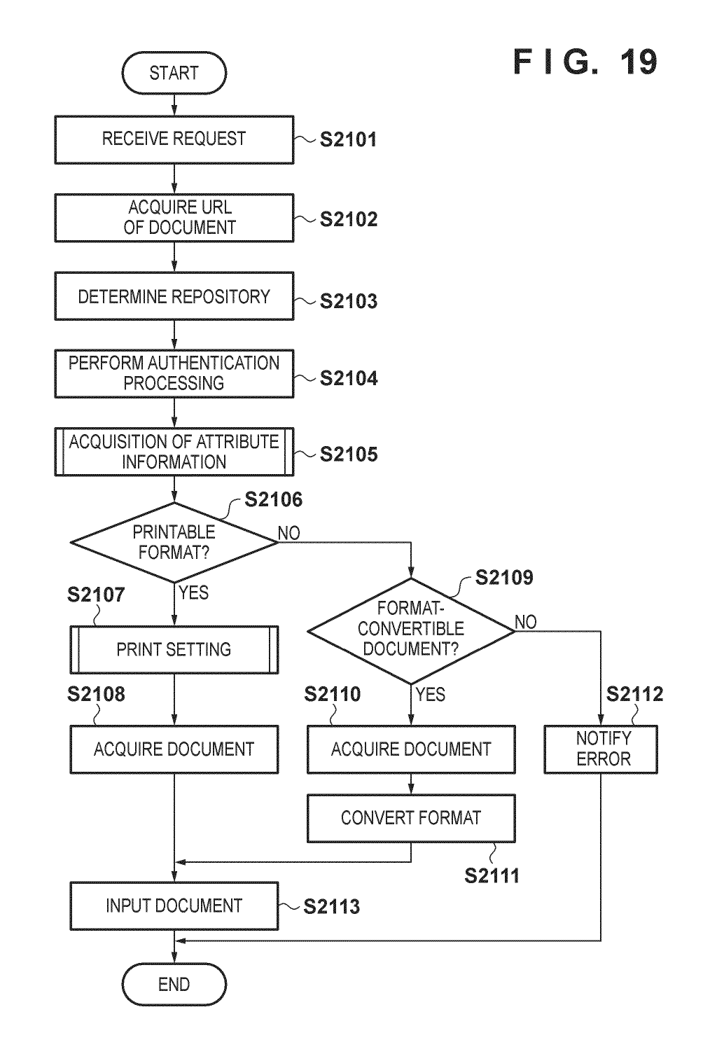

In step S1701, a browser 406 or 407 checks whether an online document 602 has been encrypted. Details of this processing will be described later with reference to FIG. 17. Steps S1702 to S1706 are the same as steps S901 to 5905 in FIG. 9. In step S1707, a sort processing unit 402 updates data of an unprintable document management table 1300. Details of this processing will be described later with reference to FIG. 18. Steps S1708 to S1714 are the same as steps S906 to 5912 in FIG. 9. The processing sequence then ends.

FIG. 7B exemplifies the script of a bookmarklet 604 used in step S1701. A script 1800 represents a script file and is executed by the browser 406 or 407. The browser 406 or 407 acquires information of a tool in a client terminal that opens the online document 602. If the tool can browse the encrypted online document 602 based on the acquired tool information, the browser 406 or 407 adds the security attribute of the online document 602 to the URL, and sends the resultant URL to the URL of a request reception unit 401. A description 1801 defines this processing.

If the acquired tool cannot browse the encrypted online document 602, the URL of the online document 602 displayed on the browser 406 or 407 is sent to the URL of the request reception unit 401 of the control server 102. A description 1802 defines this processing. Whether the acquired tool can browse the encrypted online document 602 is determined to check whether the acquired online document 602 has been encrypted, and use the determination result as information for determining whether the online document 602 is printable.

[Encryption Check Processing]

FIG. 17 is a flowchart showing processing of sending a print request containing encryption/non-encryption from the browser 406 or 407 to the request reception unit 401 according to the embodiment. Step S1901 is the same as step S801. In step S1902, the browser 406 or 407 receives a selection operation to a bookmark 603 from the user, and loads and executes the script of a bookmarklet 604 based on the operation. In the embodiment, a script as shown in FIG. 7B is executed.

In step S1903, the browser 406 or 407 determines, based on the result of step S1902, whether the encrypted online document 602 can be browsed. If YES in step S1903, the browser 406 or 407 sends a URL 601 and security attribute information (encryption information) of the online document 602 to the request reception unit 401 in accordance with the bookmarklet 604 executed in step S1902 (step S1904). If NO in step S1903, the browser 406 or 407 sends the URL 601 of the online document 602 to the request reception unit 401 in accordance with the bookmarklet executed in step S1902 (step S1905). After the processing in step S1904 or S1905, the processing sequence ends.

[Error Information Update Processing Sequence]

FIG. 18 is a flowchart showing a sequence of processing (corresponding to step S1707 in FIG. 16) of updating data of the unprintable document management table 1300 by the sort processing unit 402.

In step S2001, the sort processing unit 402 loads the security attribute information which has been sent to the request reception unit 401 in step S1904 of FIG. 17, and determines whether the online document 602 has been encrypted. If YES in step S2001, the sort processing unit 402 adds, to the unprintable document management table 1300, a record having the document repository identifier Repository, document_id, and update date & time of the online document 602 (step S2002). The processing sequence then ends. If NO in step S2001, the sort processing unit 402 determines that the online document 602 has not been encrypted, and the processing sequence ends.

In this case, the items of the unprintable document management table 1300 shown in FIG. 5D are the same as the above ones. However, the unprintable document management table 1300 may have an item different from those in the second embodiment in order to display the reason why printing is impossible. More specifically, an item indicating the cause of inhibiting printing is newly added and managed in the unprintable document management table 1300. With this information, the cause may be displayed on, for example, a browser screen 620 shown in FIG. 6C.

As described above, security information (environment or encryption) is checked in execution of a bookmarklet, and the identifier of an online document 602 for which a print instruction has failed owing to encryption is managed. The user can be notified that the online document encrypted in advance is unprintable, without acquiring it again. This can prevent wasteful communication.

### Fourth Embodiment

In the fourth embodiment, even the page count is acquired as attribute information of an online document 602, and a browser 406 or 407 hides a print setting item unusable for the acquired page count. That is, the browser of a mobile client displays only selectable setting items in accordance with attribute information (page count in this case) of an online document for which a print instruction has been issued.

[Sort Processing Sequence]

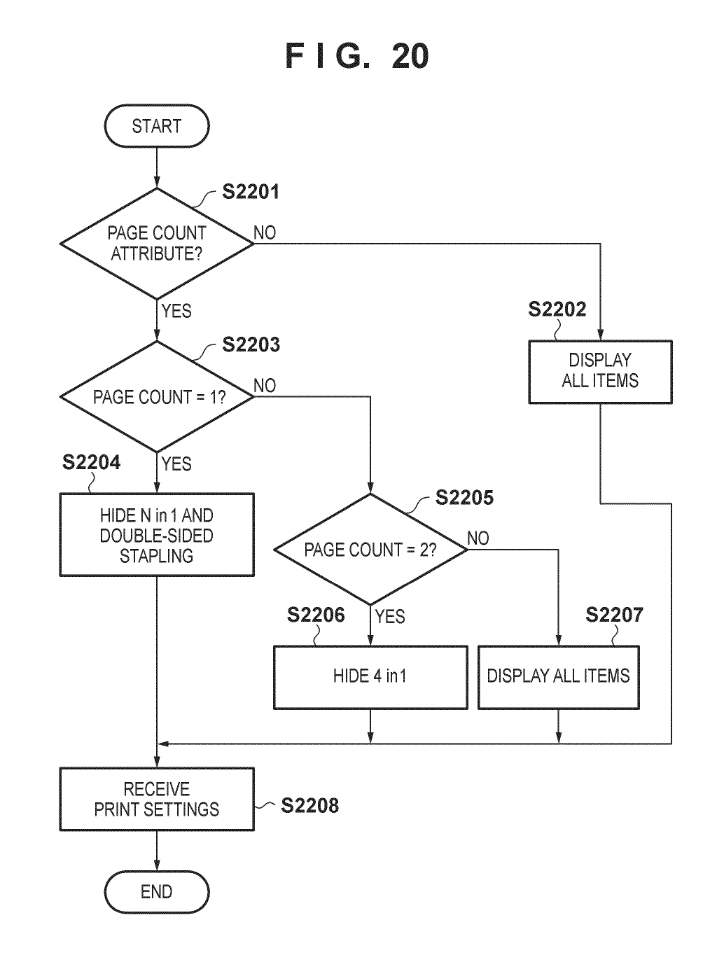

FIG. 19 is a flowchart showing a processing sequence of receiving a print request by a control server 102, acquiring the attribute of a document, and sorting processes based on the document attribute acquisition result. This processing sequence corresponds to FIG. 9 described in the first embodiment. A description of the same processes will not be repeated. Steps S2101 to S2106 are the same as steps S901 to 5906 in FIG. 9. In step S2107, a sort processing unit 402 sends a print setting screen to the browser 406 or 407 based on attribute information of the online document 602, and receives a print instruction. Details of this processing will be described with reference to FIG. 20. Steps S2108 to S2113 are the same as steps S907 to S912 in FIG. 9. The processing sequence then ends.

[Print Setting Reception Processing Sequence]

FIG. 20 is a flowchart showing a sequence of processing (corresponding to step S2107 in FIG. 19) of sending a print setting screen from the sort processing unit 402 to the browser 406 or 407 based on attribute information of the online document 602, and receiving a print instruction.

In step S2201, the sort processing unit 402 determines whether pieces of attribute information of the online document 602 that have been acquired in step S2105 contain one indicating the page count. If NO in step S2201, the sort processing unit 402 sends, to the browser 406 or 407 via a request reception unit 401, a browser screen 630 in which all selection items are valid, and the browser 406 or 407 displays the browser screen 630 (step S2202). If YES in step S2201, the sort processing unit 402 determines whether attribute information indicating the page count of the online document 602 is “1” (step S2203).

If YES in step S2203, the sort processing unit 402 sends, to the browser 406 or 407 via the request reception unit 401, the browser screen 630 in which Nin1 setting and double-sided setting unnecessary for 1-page printing are hidden, and the browser 406 or 407 displays the browser screen 630 (step S2204). If NO in step S2203, the sort processing unit 402 determines whether attribute information indicating the page count of the online document 602 is “2” (step S2205). If YES in step S2205, the sort processing unit 402 sends, to the browser 406 or 407 via the request reception unit 401, the browser screen 630 in which 4in1 setting unnecessary for 2-page printing is hidden, and the browser 406 or 407 displays the browser screen 630 (step S2206). If NO in step S2205, the sort processing unit 402 sends, to the browser 406 or 407 via the request reception unit 401, the browser screen 630 in which all print setting selection items are displayed, and the browser 406 or 407 displays the browser screen 630 (step S2207). After the processing in step S2202, S2204, S2206, or S2207, the sort processing unit 402 accepts print settings in the browser screen 630 via the request reception unit 401, and saves them in an indirect storage unit 303 in step S2208. The processing sequence then ends.

As described above, the page count is acquired as attribute information of the online document 602, and the browser 406 or 407 can hide a print setting item unusable for the acquired page count. The fourth embodiment does not display any improper choice when the screen size is limited and an information amount displayable at once is limited, like a smartphone. In addition to the effects of the first embodiment, the fourth embodiment can improve user friendliness without impairing user visibility or operability.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-195072, filed Aug. 31, 2010, which is hereby incorporated by reference herein in its entirety.

What is claimed is:

1. A network printing system comprising a client terminal, a control server which controls processing for an online document on a network, and an image forming apparatus,
said client terminal comprises a print instruction unit configured to send a print instruction for the online document to said control server by executing processing defined in a script language for the online document accessed via a Web browser of said client terminal, and
said control server comprises:
a format determination unit configured to receive the print instruction sent from said client terminal, and to determine whether the online document designated by the print instruction has a document format printable by the image forming apparatus;
a conversion determination unit configured, when said format determination unit determines that the online document is unprintable, to determine whether a document format of the online document designated by the print instruction can be converted;
a conversion unit configured, when said conversion determination unit determines that the document format can be converted, to convert the document format of the online document into a printable document format; and
an input unit configured to input actual data of the online document of the printable document format as a printing target in the image forming apparatus.

2. The system according to claim 1, wherein in said client terminal, the processing defined in the script language is registered as a bookmarklet in the Web browser, and when printing the accessed online document, processing of said print instruction unit is executed in response to selecting the bookmarklet by a user.

3. The system according to claim 1, wherein in the processing defined in the script language in said client terminal, the online document is specified from a URL of the online document accessed by a user.

4. The system according to claim 1, wherein said control server further comprises
a storage unit configured to store the online document when the online document designated by the received print instruction is unprintable, and
a notification unit configured, when a print instruction is issued for an online document identical to the online document stored in said storage unit, to notify a user that the online document is unprintable, without acquiring actual data of the online document.

5. The system according to claim 1, wherein
when executing the processing defined in the script language for the online document accessed via the Web browser of said client terminal, said print instruction unit of said client terminal determines whether the online document has been encrypted, and when the online document has been encrypted, further sends information about encryption of the online document to said control server, and
said control server further comprises
a storage unit configured to store the online document when said control server receives the print instruction sent from said client terminal and determines, based on the information about encryption, the online document designated by the print data to be unprintable owing to encryption, and
a notification unit configured, when a print instruction is issued for an online document identical to the online document stored in said storage unit, to notify a user that the online document is unprintable, without acquiring actual data of the online document.

6. The system according to claim 1, wherein said control server further comprises
an acquisition unit configured to acquire information about a page count of the online document, and
a sending unit configured to send, to said client terminal, a setting screen which displays only a print setting selectable for the page count acquired by said acquisition unit.

7. The system according to claim 1, wherein information about an online document stored in a storage unit of said control server includes at least a URL of the online document, a document format, document format conversion possible/impossible information, and print setting information.

8. A client terminal in a network printing system including the client terminal, a control server which controls processing for an online document on a network, and an image forming apparatus, comprising a print instruction unit configured to send a print instruction for the online document to the control server by executing processing defined in a script language for the online document accessed via a Web browser of the client terminal,
wherein the processing defined in the script language is registered as a bookmarklet in the Web browser, and when printing the accessed online document, processing of said print instruction unit is executed in response to selecting the bookmarklet by a user.

9. A printing method in a network printing system including a client terminal, a control server which controls processing for an online document on a network, and an image forming apparatus, comprising:
in the client terminal,
a print instruction step of sending a print instruction for the online document to the control server by executing processing defined in a script language for the online document accessed via a Web browser of the client terminal;
in the control server,
a format determination step of receiving the print instruction sent from the client terminal, and determining whether the online document designated by the print instruction has a document format printable by the image forming apparatus;
a conversion determination step of, when the online document is determined in the format determination step to be unprintable, determining whether a document format of the online document designated by the print instruction can be converted;
a conversion step of, when the document format is determined in the conversion determination step to be able to be converted, converting the document format of the online document into a printable document format; and
an input step of inputting actual data of the online document of the printable format as a printing target in the image forming apparatus.
